(19) United States
(12) Patent Application Publication
(10) Pub. No.: US 2002/0039985 A1
(43) Pub. Date: Apr. 4, 2002

(54) Cleaning solution

(76) Inventor: Christ Lam, Duarte, CA (US)

Correspondence Address: Matthew J. Peirce, Esq., 1550 Starlight Canyon Avenue, Las Vegas, NV, 89123, US

(21) Appl. No.: 09/970,493

(22) Filed: Oct. 3, 2001

Related U.S. Application Data
(60) Provisional application No. 60/237,126, filed on Oct. 3, 2000.

(51) Int. Cl. C11D 17/08

(52) U.S. Cl. 510/275

(57) ABSTRACT

A new and improved solution is disclosed that protects and shines plastic, leather, and vinyl surfaces. The product has the capability of being bought in a wide variety of fragrances, including baby powder, lemon, pine, coconut, jasmine, bubble gum, strawberry, banana, vanilla, green apple, coffee, and mint.

### I. BACKGROUND OF THE INVENTION

The present invention is that of a new and improved solution that protects and shines plastic, leather, and vinyl surfaces.

### II. DESCRIPTION OF THE PRIOR ART

U.S. Pat. No. 5,518,533, issued to Howe, discloses a protective composition for automotive painted surfaces.

U.S. Pat. No. 5,432,217, issued to O'Lenick, discloses a stable composition and process for cleaning, protecting, preserving, and renewing surfaces, especially rubber and other polymers.

U.S. Pat. No. 5,085,695, issued to Randen et al., discloses an essentially wax-free cleaner-polisher composition that cleans while maintaining excellent gloss and superior protection against water and a mixture of alcohol and water damage in a one-step application.

U.S. Pat. No. 3,956,174, issued to Palcher, discloses a process for protecting, preserving, and renewing surfaces, especially rubber and other natural and synthetic polymers, leather, wood, painted surfaces and metal.

### III. SUMMARY OF THE INVENTION

The present invention is that of a new and improved solution that protects and shines plastic, leather, and vinyl surfaces. The product has the capability of being bought in a wide variety of fragrances, including baby powder, lemon, pine, coconut, jasmine, bubble gum, strawberry, banana, vanilla, green apple, coffee, and mint.

There has thus been outlined, rather broadly, the more important features of a solution for cleaning and protecting surfaces in order that the detailed description thereof that follows may be better understood and in order that the present contribution to the art may be better appreciated. There are, of course, additional features of the solution for cleaning and protecting surfaces that will be described hereinafter and which will form the subject matter of the claims appended hereto.

In this respect, before explaining at least one embodiment of the solution for cleaning and protecting surfaces in detail, it is to be understood that the solution for cleaning and protecting surfaces is not limited in its application to the details of construction and to the arrangements of the components set forth in the following description or illustrated in the drawings. The solution for cleaning and protecting surfaces is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present solution for cleaning and protecting surfaces. It is important, therefore, that the claims be regard as including such equivalent constructions insofar as they do not depart from the spirit and scope of the present invention.

It is therefore an object of the present invention to provide a solution for cleaning and protecting surfaces which has all of the advantages of the prior art and none of the disadvantages.

It is another object of the present invention to provide a solution for cleaning and protecting surfaces which may be easily and efficiently manufactured and marketed.

It is another object of the present invention to provide a solution for cleaning and protecting surfaces which is of durable and reliable construction.

It is yet another object of the present invention to provide a solution for cleaning and protecting surfaces which is economically affordable and available to the buying public.

It is yet another object of the present invention to provide a solution for cleaning and protecting surfaces which provides additional benefits not present in the prior art.

Other objects, features and advantages of the present invention will become more readily apparent from the following detailed description of the preferred embodiment when considered with the attached drawings and appended claims.

### IV. DESCRIPTION OF THE PREFERRED EMBODIMENT

FIG. 1 shows a perspective view of one possible embodiment of a container 2 utilized with the present invention. The solution of the present invention would comprise a combination of “Armorall” product and car freshener. Preferably, the Armorall would comprise 80-90% of the volume of the resulting solution, while the fragrance would comprise the other 10-20% of the volume of the resulting solution.

It should be noted that instead of “Armorall,” a user could alternatively use “Turtle 2000” or “Turtle 2000 Professional.” Alternatively, a user could use other similar, analogous cleaning solutions that are similar in chemical composition and/or purpose.

To use the solution, a user would spray it on and then wipe it up, and the result would be that of a clean, nice-smelling vehicle. The present invention would be an improvement over prior art in that it is easy to use and would be much more long lasting than compared to air freshener currently available for vehicles. The present invention would also eliminate the damage to dash surfaces that is usually present with currently available stickers that act as vehicle air fresheners.

What I claim as my invention is:

1. A liquid cleaning composition for cleaning plastic, leather, and vinyl surfaces comprising:
(a) a volume of cleaning solution, the volume of cleaning solution occupying between eighty percent and ninety percent of the volume of the cleaning composition,
(b) a fragrance, the fragrance being in liquid form, the fragrance occupying the remaining ten percent to twenty percent of the volume of the cleaning composition,
(c) wherein a user would spray the cleaning composition onto a surface to be cleaned, and further wherein a user would then wipe up the cleaning composition.

2. A cleaning composition for cleaning plastic, leather, and vinyl surfaces according to claim 1 wherein the volume of cleaning solution would be the “Armorall” brand of cleaning solution.

3. A cleaning composition for cleaning plastic, leather, and vinyl surfaces according to claim 1 wherein the volume of cleaning solution would be the “Turtle 2000” brand of cleaning solution.

4. A cleaning composition for cleaning plastic, leather, and vinyl surfaces according to claim 1 wherein the volume of cleaning solution would be the “Turtle 2000 Professional” brand of cleaning solution.

5. A cleaning composition for cleaning plastic, leather, and vinyl surfaces according to claim 1 wherein the fragrance would be one selected from a group consisting of baby powder, lemon, pine, coconut, jasmine, bubble gum, strawberry, banana, vanilla, green apple, coffee, and mint.
